(19) United States
(12) Patent Application Publication
(10) Pub. No.: US 2021/0047070 A1
(43) Pub. Date: Feb. 18, 2021

(54) TELESCOPING BOXES, BLANKS, AND SYSTEMS FOR HEAVY BAG-IN-BOX DISPENSED PRODUCTS

(71) Applicant: Georgia-Pacific Corrugated LLC, Atlanta, GA (US)

(72) Inventor: Carl Anthony Bulls, Jr., Norcross, GA (US)

(21) Appl. No.: 16/906,127

(22) Filed: Jun. 19, 2020

Related U.S. Application Data
(60) Provisional application No. 62/886,082, filed on Aug. 13, 2019.

(51) Int. Cl. B65D 5/32; B65D 77/06; B65D 5/70; B65D 83/00

(52) U.S. Cl. CPC B65D 5/326; B65D 77/065; B65D 5/703; B31B 2105/0022; B65D 2517/0008; B65D 2231/001; B65D 83/0055

(57) ABSTRACT

Corrugated boxes, box blanks, and systems for individually shipping a bag of liquid stored therein and converting into a bag-in-box dispenser are provided. An example box comprises a top portion comprising a plurality of walls. The top portion defines a perforation feature defined on the front wall and a front top flap extending from the front wall. The perforation feature is defined by a series of perforations and is removable. A bottom portion comprises a plurality of walls and is sized to fit within an opening defined by the top portion. The bottom portion defines an opening configured to receive the bag of liquid. The box is configured to store a bag of liquid ranging from 3 to 6 gallons and is designed to pass individual box shipping test standards, such as ISTA and SIOC test standards. Methods of forming the box are also provided.

### BACKGROUND

Bag-in-box dispensers provide a user access to dispense liquid product (e.g., soap, oil, cleaner, wine, etc.) from a bag that is held within a box. In some cases, a user accesses a dispensing tap (e.g., valve, opening, nozzle, etc.) on the bag (often extending through a hole in the box) to dispense liquid from the bag, while the majority of the bag is stored within the box. Conventional box designs for bag-in-box dispensers include a corrugated box that is designed to be shipped on a pallet in an upright orientation (e.g., with other like boxes/product). Then, each bag-in-box product is taken off the pallet for use and/or stocking on a shelf for sale. Notably, shipping and handling under such circumstances puts predictable and largely unidirectional stress on the box such that box designs can afford to be limited while still maintaining the box and bag stored inside in working order through distribution to the final destination. For example, the strength characteristics for the box can be designed with the knowledge that the box will only be shipped in the upright orientation.

### BRIEF SUMMARY

Embodiments of the present invention are directed to corrugated box designs that are designed to withstand the individual e-commerce shipping environment, which includes the same shipping and handling that occurs for other types of boxes in this environment (e.g., throwing the boxes, dropping the boxes in all orientations, vibration within a transport vehicle with weight stacked on top). Importantly, in the individual e-commerce shipping environment, there is no predictable orientation for the box design, and all of the above (and other) circumstances occur in all orientations. Thus, while prior box designs for bag-in-box dispensers could predict their orientation (e.g., upright) and had the benefit of relatively safe/professional handling and transfer, the present invention takes into account all of those uncertainties and likely occurrences to still deliver an intact box to the final destination.

For bag-in-box products, it is very important to keep the box (and any perforations) intact during shipping because otherwise the liquid product in the bag may spill out if the bag breaks, rips, or tears, as the bag is more susceptible to breaking and/or leaking if the box is compromised/weakened. That situation is of extra concern because spilled liquid can cause significant damage to other boxes or transportation equipment (e.g., trucks, conveyors, warehouse flooring, etc.) during shipping and is difficult to clean (e.g., in comparison to non-liquid products being shipped). In this regard, the box designs of the present invention are engineered to withstand and pass various standardized distribution sequences that are specifically designed to replicate harsh conditions that a box goes through during individual e-commerce shipping (e.g., through various known consumer-based shipping services). Such example safety test standards include the International Safe Transit Association (ISTA) test standards, including the Ship In Own Container (SIOC) test protocols. In such a regard, the resulting box designs of the present invention are the product of significant testing, as many other designs were disregarded after failing such tests.

Embodiments of the present invention provide example box designs for safely and successfully transporting a heavy bag of liquid and still enabling conversion into a bag-in-box dispenser. For example, various box designs described herein are designed to hold a bag of liquid with volume ranging from 3 gallons to 6 gallons (though other ranges are contemplated) and/or a weight ranging from 25 lbs. to 55 lbs. (though other ranges are contemplated). In some embodiments, such box designs may utilize a telescoping half-slotted container (HSC) and a telescoping HSC with rollover flaps, although embodiments of the present invention are not meant to be limited to such a box design. In this regard, notably, embodiments of the present invention provide a box design with various features that are designed to aid in safe transport of the stored bag, while still providing for the conversion into a useful bag-in-box dispenser upon arrival at the final destination.

To achieve such a goal, some embodiments of the present invention provide a box design with a top portion and a bottom portion. The top portion includes a perforation feature that extends across at least a portion of a front wall and a top front flap such that the perforation feature extends across a top edge of the formed box. The bottom portion may include a cut-out feature (e.g., pre-removed or perforated) in the front wall that aligns with the perforation feature of the top portion, where the cut-out feature is shaped to hold a dispensing tap (e.g., valve) of the bag once the bag-in-box dispenser is converted. In this regard, upon arrival at the final destination, a user may remove the perforation feature, reach in and arrange the dispensing tap into the cut-out feature, and rotate the entire box 180° to, thus, convert the box into the bag-in-box dispenser with the dispensing tap available for use. Various additional features, such as a finger access portion, use of double-walled corrugate, rollover flaps, location of a glue joint (e.g., a side flange), among others described herein, are contemplated for some embodiments, and may aid in providing safe transport of the stored bag, while still providing for easy conversion into a useful bag-in-box dispenser upon arrival at the final destination.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 shows a top perspective view of an example corrugated box, in accordance with some embodiments discussed herein;

FIG. 2 shows a bottom perspective view of the example corrugated box shown in FIG. 1, in accordance with some embodiments discussed herein;

FIG. 3 shows an example corrugated box with the top portion separated from the bottom portion, in accordance with some embodiments discussed herein;

FIG. 4 shows a bottom perspective view of a top portion of the example corrugated box shown in FIG. 1, in accordance with some embodiments discussed herein;

FIG. 5 shows a close-up perspective view of an inside of the top portion of the example corrugated box shown in FIG. 1, in accordance with some embodiments discussed herein;

FIG. 6 shows a top perspective view of a bottom portion of the example corrugated box shown in FIG. 1, in accordance with some embodiments discussed herein;

FIG. 7 illustrates a layout of a box blank for the example corrugated box shown in FIG. 1, in accordance with some embodiments discussed herein;

FIG. 8 illustrates an example method of converting an example corrugated box into a bag-in-box dispenser, in accordance with some embodiments discussed herein;

FIG. 9 shows a top perspective view of the example corrugated box shown in FIG. 1, wherein a perforation feature has been removed, in accordance with some embodiments discussed herein;

FIG. 10 shows a top perspective view of the example corrugated box shown in FIG. 9, wherein a dispensing tap of a bag stored within the box has been positioned into a dispensing position through the portion of the box that was removed, in accordance with some embodiments discussed herein;

FIG. 11 shows a side perspective view of the example corrugated box shown in FIG. 10, wherein the box has been moved (e.g., rotated) to a dispensing orientation, in accordance with some embodiments discussed herein; and

FIG. 12 illustrates a flowchart of an example method of forming a box, shipping the box with a bag stored therein, and converting the box into the bag-in-box dispenser, in accordance with some embodiments discussed herein.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout.

Notably, while some embodiments describe various positional qualifiers for various features, such as “top”, “bottom”, “front”, “back”, “side”, etc. embodiments described herein are not meant to be limited to such qualifiers unless otherwise stated. Along these lines, and as an example, the “top” portion is also contemplated to be a “bottom” portion depending on the box design/orientation or a “front” wall may be a “side” wall depending on the box design/orientation. The directional qualifiers herein are generally used to aid in describing the invention in the context of the drawings and/or description but are not otherwise intended to be limiting.

While some embodiments describe a “user”, use of such a term herein is not meant to be limited to a person or a single person, as the “user” may be an end user, a consumer, a manufacturer, among other types of users along a supply chain in relation to the box design. Further, when utilizing the word “user”, the actor(s) may be operating one or more machines/system that cause the intended function (e.g., forming the box or converting the box to a bag-in-box dispenser).

Various example embodiments of the present invention provide example box designs for safe shipping of a heavy bag of liquid and still enabling conversion into a bag-in-box dispenser. For example, various box designs described herein are designed to hold a bag of liquid with volume ranging from 3 gallons to 6 gallons (though other ranges are contemplated) and/or a weight ranging from 25 lbs. to 55 lbs. (though other ranges are contemplated). Some examples of possible liquids that may be shipped in such quantity include various cleaners and washing liquids, such as may be used to re-fill custodian spray bottles or other individual supplies (e.g., bottles). However, other example liquids include wine, juice, or any type of liquid that would benefit from being dispensed. Along these lines the term “liquid” used herein may refer to any type of substance in liquid state (e.g., fluid, creams, lotions, gels, water, etc.).

In some embodiments, such box designs may utilize a telescoping design with two portions, including an HSC and an HSC with rollover flaps, although embodiments of the present invention are not meant to be limited to such a box design. Other example box designs include regular slotted containers, wraparounds, overlapping slotted containers, die-cut containers, among others. Various embodiments described herein provide one or more features that alone or in combination with each other provide a suitable box design for providing safe transport of the stored bag, while still providing for easy conversion into a useful bag-in-box dispenser upon arrival at the final destination.

Notably, example box designs of the present invention are designed to withstand and pass various laboratory distribution tests that are specifically designed to replicate harsh conditions a box goes through during individual e-commerce shipping (e.g., through various known shipping services). Such example safety test standards include the International Safe Transit Association (ISTA) test standards which includes Ship In Own Container (SIOC) test standards, such as the ISTA Series 6-Amazon.com-SIOC test protocol (i.e., the ISTA Series 6-Amazon.com-SIOC test for 2018, with a version date with a last technical change in March 2018 and a last editorial change in March 2018—where further details are available at www.ista.org). Based on the packaging weight and/or girth, the box may need to undergo an appropriate Type test (e.g., Type A for under 50 lbs. or Type B for over 50 lbs.). For example, the SIOC test standards require that the box be packaged as planned to be shipped and be put through a testing protocol that includes numerous drops from various heights with the box falling on different sides (e.g., walls, faces) and edges. This simulates possible drops that may occur during handling by shipping personnel. Next, the same box undergoes vibration testing that includes prolonged vibration (e.g., for 2.5 hours, although other durations are contemplated) with weight placed on top of the box—again at specified orientations (often required to be on the “weakest” face, e.g., an orientation which the corrugated flutes are not vertically oriented relative to the applied compression forces). This simulates travel within a transport vehicle (e.g., an airplane, train, truck, van, etc.) with other boxes being stacked on top of it. Finally, the same box then goes through more drops of varying height and on varying sides, corners, or edges, with one of the last drops being at a greater height and on the “weakest” side or edge. This once again simulates possible drops that may occur during handling by shipping personnel. Depending on the desired outcome, the box may need to pass certain test criteria in order to pass the tests. Notably, the ISTA Series 6-Amazon.com-SIOC test protocol acceptance criteria includes (i) the product is fully functional in its intended use, (ii) there are no leaks, (iii) any tamper evidence application is not compromised (e.g., seal integrity is intact), and (iv) any secondary packaging that is considered part of the product is free from serious damage/indentations/scratching.

The box may be designed to pass the ISTA Series 6-Amazon.com-SIOC test protocol or other shipping test protocol (e.g., to be able to ship using individual shipping options—such as the mail, truck delivery, etc.), and also maintain certain form standards that enable it to be converted into the bag-in-box dispenser upon reaching its final destination. In this regard, the box should survive (e.g., withstand) the entire test process while maintaining a desired form such that the flaps and any perforation features are intact, and with the bag maintained within the box without liquid spilling/leaking therefrom, such that the box may be converted into a functioning bag-in-box dispenser as intended. In some embodiments, the box may be considered to maintain a desired form even with some flexing, but without an undesirable degree of bulging, such as may include significant changes in the shape of the box to limit its function (e.g., cause perforations to tear or release prematurely, cause flaps to tear or open, cause adhesive joints to fail or open prematurely, cause the box to no longer fit in a designated spot at the final destination (e.g., in a storage rack or storage position) or be suitable for stacking or supporting additional loads (e.g., on top of the box), prevent full evacuation of the liquid in the bag, cause decreased overall rigidity or integrity of the box to hinder transportation or manipulation of the box). In such a regard, the resulting box designs of the present invention are the product of significant testing, as many other designs were disregarded after failing such tests.

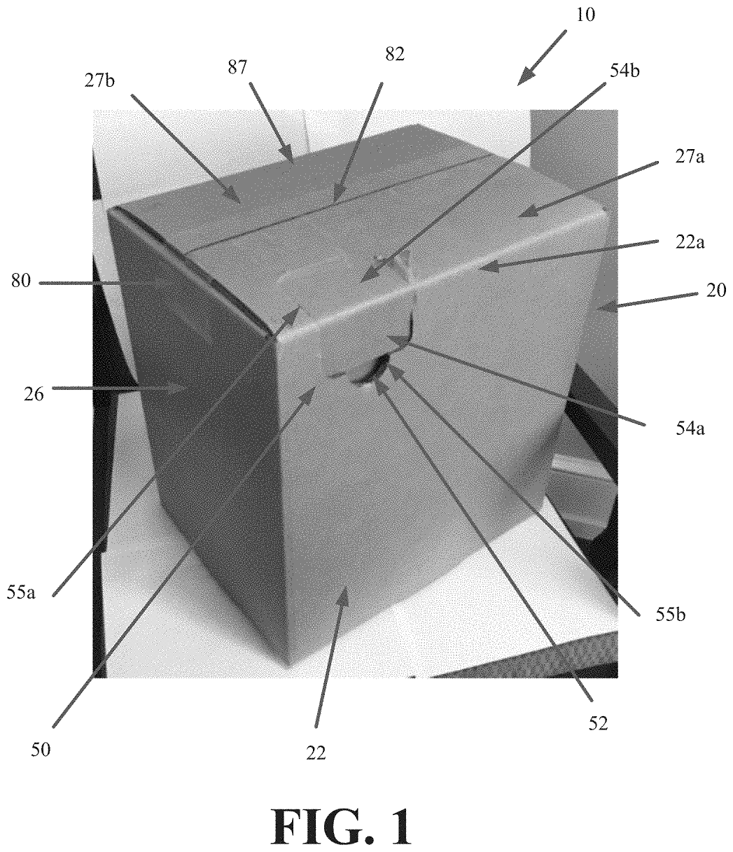

An example corrugated box 10 that accomplishes such advantages, including passing the above noted test standards, is shown in FIG. 1. With reference to FIGS. 1-3, the corrugated box 10 is formed of a top portion 20 and a bottom portion 30.

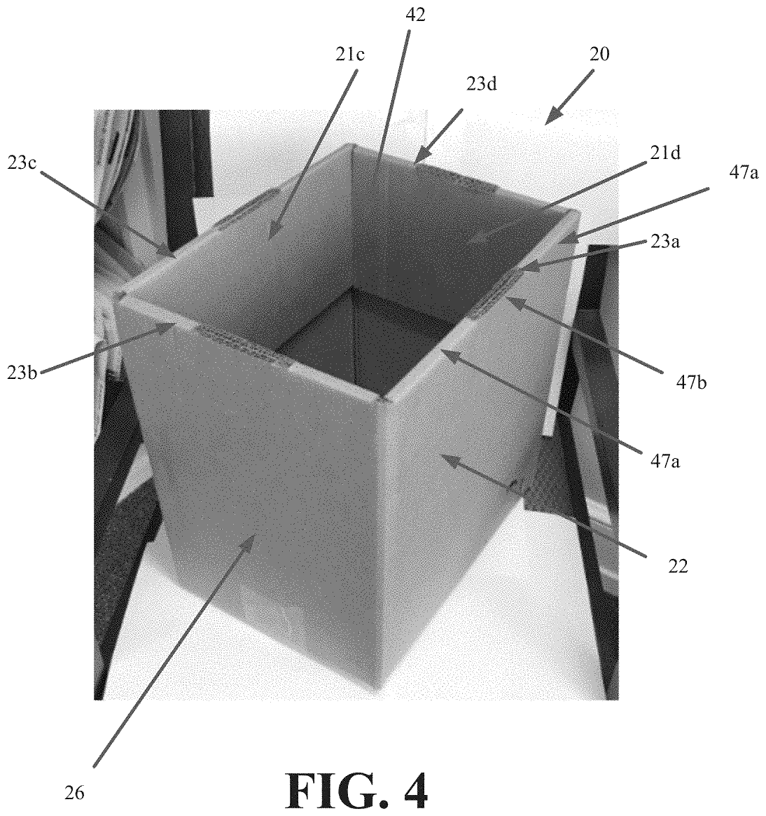

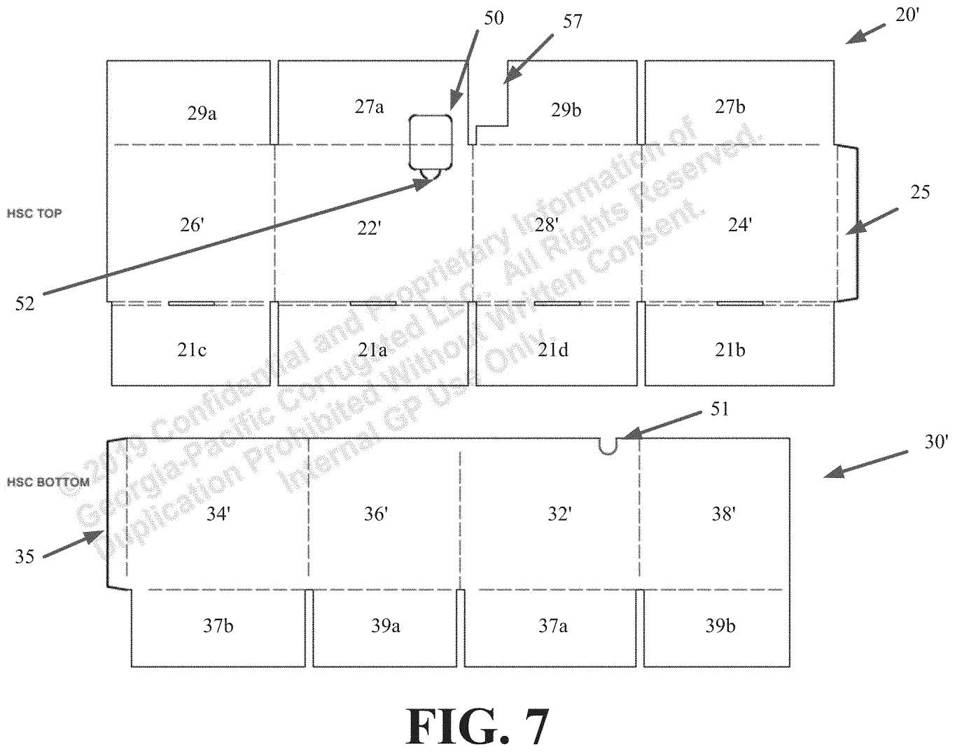

The top portion 20 comprises four walls (e.g., faces): a front wall 22, a back wall 24, and two opposing side walls 26, 28. Corresponding panels (e.g., a front panel 22′, back panel 24′, a first side panel 26′, and a second side panel 28′) can be seen in the box blank form of the top portion 20′ shown in FIG. 7. In this regard, the term “panels” may be used when in box blank form and the term “walls” may be used when in the erected/formed box form. As shown, the top portion 20 also includes a side flap 25 (notably, the side flap 25 may be attached to any suitable wall/panel depending on the desired box design). To form the box top portion 20 shown in FIG. 1, the side flap 25 may be attached, such as using adhesive (although additional or alternative attachment means can be utilized, such as tape, staples, etc.), to the second side wall 28. When formed, the top portion defines an opening 42 (shown in FIG. 4, which shows the top portion 20 alone in an upside down orientation).

With further reference to FIG. 7, the top portion 20 also includes top flaps 27a, 27b, 29a, 29b that each extend from corresponding panels 22′, 24′, 26′, 28′. In particular, a top front flap 27a extends upwardly from the front panel 22′; a top back flap 27b extends upwardly from the back panel 24′; a top first side flap 29a extends upwardly from the first side panel 26′; and a top second side flap 29b extends upwardly from the second side panel 28′. Returning to FIG. 1, the top flaps of the top portion 20 fold from their walls to form a top 87. In this regard, the top first side flap 29a and the top second side flap 29b may fold underneath the top front flap 27a and the top back flap 27b, and the edges of the top front flap 27a and the top back flap 27b may meet together or close together, forming a flap gap 82. Although shown at a mid-point along a width of the top 87, the flap gap 82 may be positioned anywhere along a width of the top 87 (e.g., closer to one side or the other). Likewise, the box design may be formed to include overlapping top or bottom flaps. One or more pieces of tape 80 may extend across the flap gap 82 to form the top 87 (although additional or alternative attachment means can be utilized, such as adhesive, staples, etc. to otherwise secure the flaps).

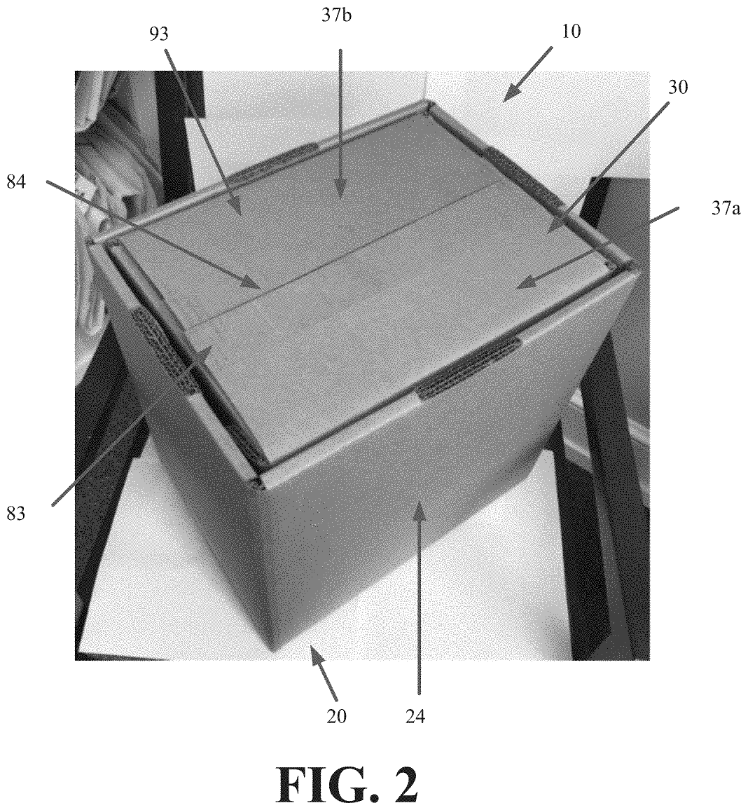

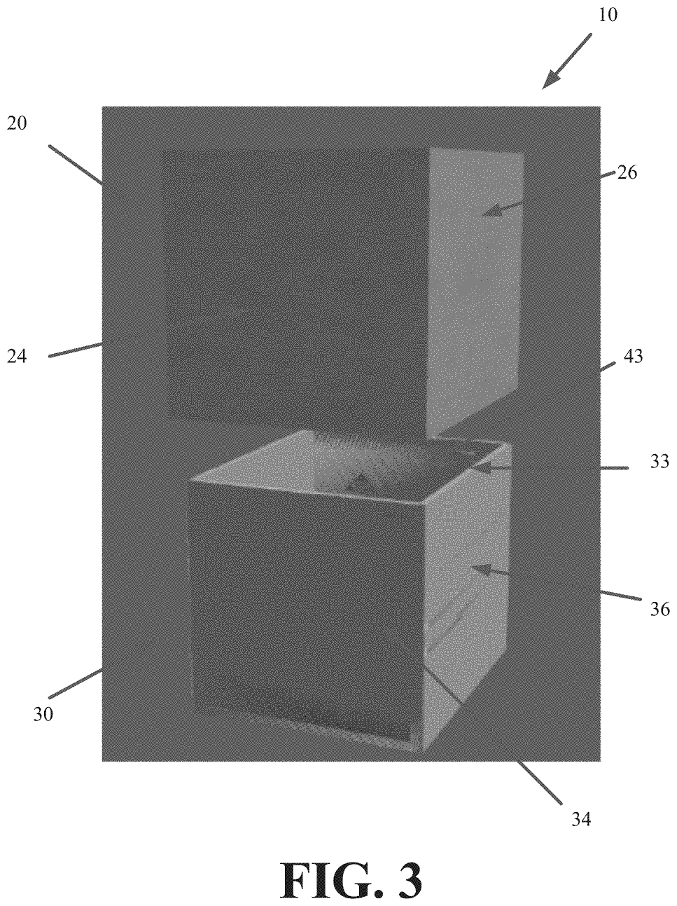

Returning to FIG. 7, the top portion 20 also includes bottom flaps 21a, 21b, 21c, 21d that each extend from corresponding panels 22′, 24′, 26′, 28′. In particular, a bottom front flap 21a extends downwardly from the front panel 22′; a bottom back flap 21b extends downwardly from the back panel 24′; a bottom first side flap 21c extends downwardly from the first side panel 26′; and a bottom second side flap 21d extends downwardly from the second side panel 28′. Returning to FIG. 4, which shows the top portion 20 alone in an upside down orientation, the bottom flaps 21a-d may be folded inside the opening 42 to provide extra rigidity (e.g., increased hoop strength) to the box 10. In some embodiments, the edges 23a-d formed by folding of the bottom flaps 21a-d may include one or more slots 47b (e.g., defined between continuous portions 47a). The slots 47b may be configured to provide relative point(s) of weakness, such as to enable folding of the bottom flaps while still maintaining desired rigidity. In some embodiments, utilizing the slots 47b may provide increased strength in some orientations. As noted herein, the opening 42 is sized to receive and contain the bottom portion 30 (such as shown in FIGS. 2-3). Further, in some embodiments, such as illustrated, the length of the walls correlates to the length of the walls of the bottom portion 20 such that the bottom edges 23a-d shown in FIG. 4 align with the bottom 93 of the bottom portion 30, such as shown in FIG. 2. Although the depicted embodiment includes bottom (e.g., “rollover”) flaps for the top portion, in some embodiments, the top portion may not include bottom (e.g., rollover) flaps, such that it forms a standard half-slotted container.

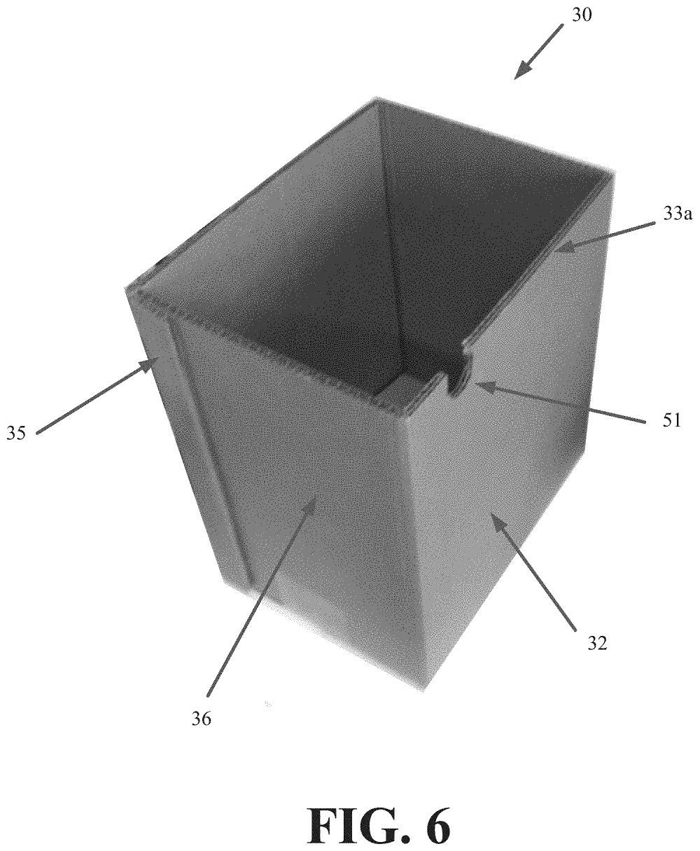

The bottom portion 30 comprises four walls: a front wall 32, a back wall 34, and two opposing side walls 36, 38. Corresponding panels (e.g., a front panel 32′, back panel 34′, a first side panel 36′, and a second side panel 38′) can be seen in the box blank form of the bottom portion 30′ shown in FIG. 7. As shown, the bottom portion 30 also includes a side flap 35 (notably, the side flap 35 may be attached to any suitable wall/panel depending on the desired box design). To form the box bottom portion 30 shown in FIG. 6, the side flap 35 may be attached, such as using adhesive (although additional or alternative attachment means can be utilized, such as tape, staples, etc.), to the outside of the second side wall 38. When formed, the bottom portion defines an opening 43 (shown in FIG. 3) that is sized to receive and store a bag, such as a bag of liquid of volume ranges from 3 gallons to 6 gallons. Notably, by attaching the side flap 35 to an outside surface of one of the walls, the side flap (which contains a rough corrugated edge) is separated from the stored bag held within the opening 43 of the bottom portion 30 so as to avoid damage to the stored bag during shipping. Of further note, the bottom portion 30 is sized to be received by and fit within the opening 42 of the top portion 20, such as shown in FIG. 2 (which shows the box 10 in an upside down orientation).

With further reference to FIG. 7, the bottom portion 30 also includes bottom flaps 37a, 37b, 39a, 39b that each extend from corresponding panels 32′, 34′, 36′, 38′. In particular, a bottom front flap 37a extends downwardly from the front panel 32′; a bottom back flap 37b extends downwardly from the back panel 34′; a bottom first side flap 39a extends downwardly from the first side panel 36′; and a bottom second side flap 39b extends downwardly from the second side panel 38′. Returning to FIG. 2, which shows the bottom portion 30 in an upside down orientation inside the top portion 20, the bottom flaps of the bottom portion 30 fold from their walls to form a bottom 93. In this regard, the bottom first side flap 39a and the bottom second side flap 39b may fold underneath the bottom front flap 37a and the bottom back flap 37b, and the edges of the bottom front flap 37a and the bottom back flap 37b may meet together (or close together), forming a flap gap 84. Although shown at a mid-point along a width of the bottom 93, the flap gap 84 may be positioned anywhere along a width of the bottom 93 (e.g., closer to one side or the other). Likewise, the box design may be formed to include overlapping top or bottom flaps. One or more pieces of tape 83 may extend across flap gap 84 to form the bottom 93 (although additional or alternative attachment means can be utilized, such as adhesive, staples, etc.).

With reference to FIG. 1, the top portion 20 of the corrugated box 10 is designed with a perforation feature 50. The perforation feature is defined by a series of perforations 55a (e.g., weak points) that help a user with removal thereof, such that the perforation feature is removable from a remainder of the top portion 20. With reference to both FIGS. 1 and 7, the perforation feature 50 is defined on the front wall 22/front panel 22′ and the front top flap 27a of the top portion 20, 20′. Although the perforation feature 50 is shown and described with respect to the front wall/panel and front top flap, in some embodiments, the perforation feature may be located on other walls/panels and/or flaps (including multiple walls/panels and flaps).

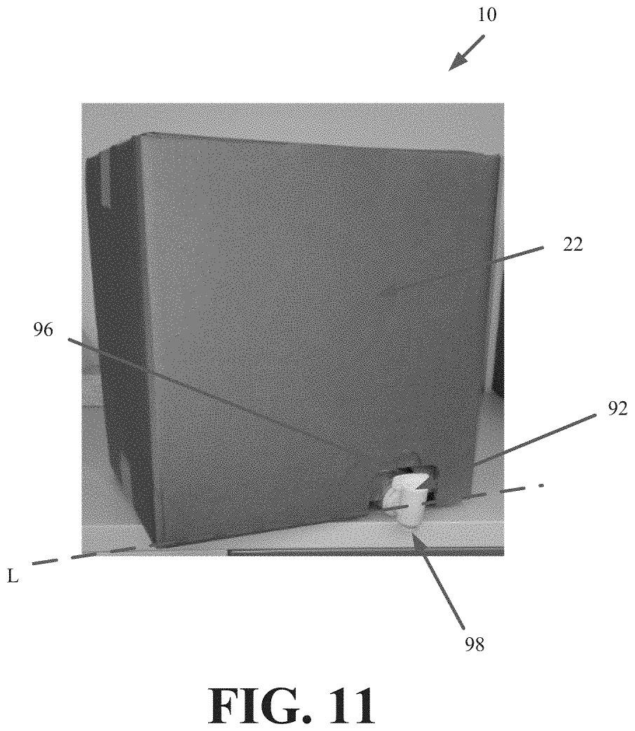

As detailed further herein, the perforation feature 50 is removable to help convert the box 10 into a bag-in-box dispenser, such as shown in FIG. 11. In this regard, a benefit of the perforation feature 50 is that it facilitates removal of a portion of the box 10 to allow a user to access a dispensing tap (e.g., valve, opening, nozzle, etc.) on the bag that is held within the box 10 and enable repositioning of the dispensing tap to a dispensing position, such as at least partially extending outside of the box 10 (and, thus, accessible by a user for dispensing the liquid from the bag).

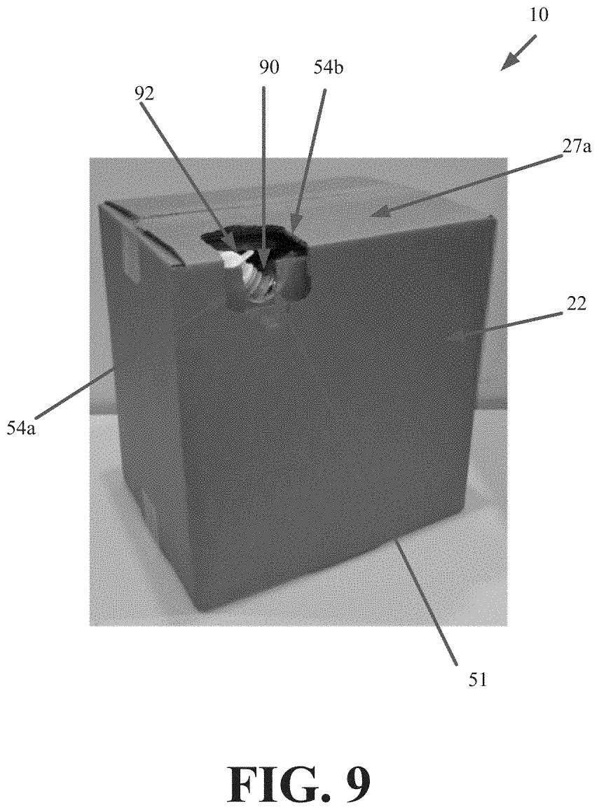

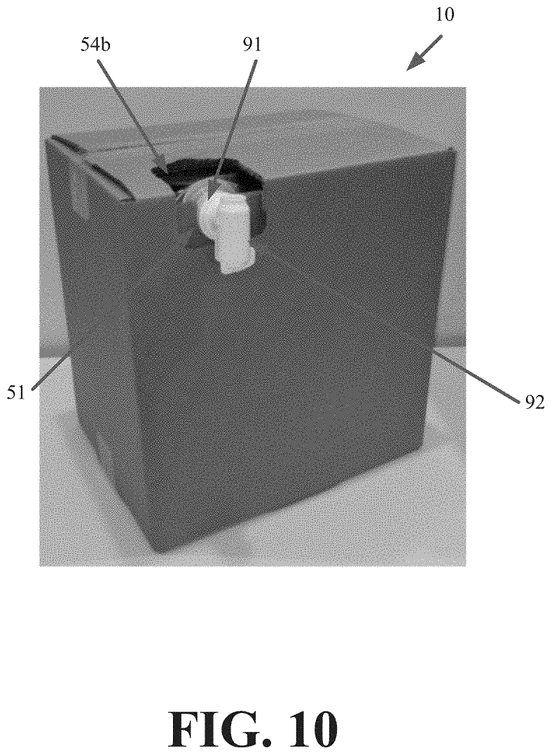

In the illustrated embodiment, the perforation feature 50 extends across the front wall 22 and the front top flap 27a such that removal of the perforation feature 50 removes a portion 54a of the front wall 22 that is adjacent and continuous with a portion 54b of the front top flap 27a that is also removed. For example, the perforation feature 50 extends across an edge 22a of the front wall 22 defined by folding of the front top flap 27a. With reference to FIGS. 9-10, by removing a continuous portion (e.g., both portions 54a and 54b), this enables a user to access the dispensing tap 92 that is stored with the bag 90 inside the box 10 and reposition the dispensing tap 92 to extend out through the front wall 22. In such a regard, with reference to FIG. 10, the perforation feature 50 defines a portion 54a of the front wall 22 that is sized to enable a dispensing tap 92 of a stored bag 90 to extend at least partially through and/or past the front wall 22 when the box is converted into the bag-in-box dispenser. Of further note, with reference to FIG. 11, a benefit to positioning the perforation feature 50 along a top edge of the front wall 22 is that when the box 10 is converted into the bag-in-box dispenser by rotating it (e.g., 180°), the dispensing tap 92 is positioned at a bottom of the bag (e.g., at/below line L) to facilitate removal of contents of the bag with the aid of gravity.

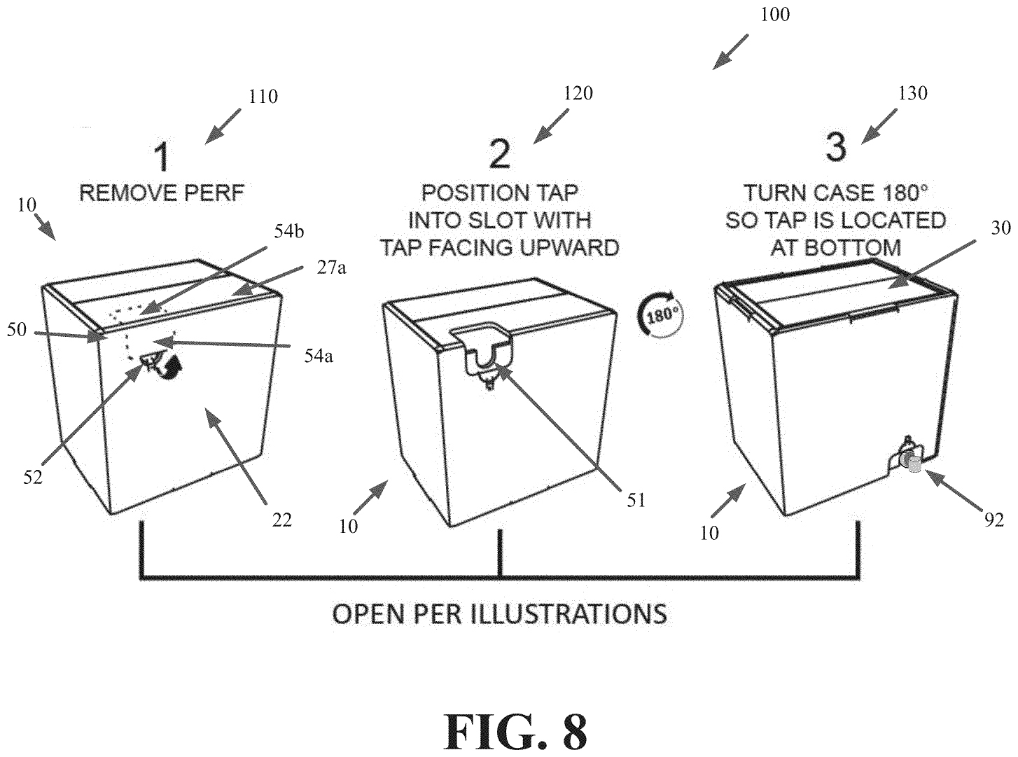

Returning to FIG. 1, the top portion 20 may further define a finger access feature 52 (further shown in FIG. 8) positioned adjacent to the perforation feature 50. The finger access feature 52 is at least partially defined by a series of perforations 55b (e.g., a separate but adjacent series of perforations than the perforation feature) and is removable separately from the perforation feature 50 to enable easier access for a user to remove the perforation feature 50. Though the finger access feature 52 is shown defined on the front wall 22, in various embodiments, the finger access feature 52 may be formed on one or more walls or top flaps. Along similar lines, though the finger access feature 52 is shown as a semi-circle, any shape may be used. Similarly, although shown and described as being removable (e.g., using a series of perforations), the finger access feature 52 in some embodiments may be pre-removed from the top portion 20.

In some embodiments, the bottom portion 30 of the box 10 may define a cut-out feature 51 that further aids in conversion into the bag-in-box dispenser. For example, with reference to FIGS. 6 and 7, the bottom portion 30, 30′ comprises a cut-out feature 51 that defines a removed portion of the front wall 32 of the bottom portion 30. In this regard, the cut-out feature 51 may be an area cut-out from the normal rectangular footprint of the front wall 32 of the bottom portion 30 (e.g., in some embodiments the front wall 32 may define a corresponding modified shape (e.g., modified from a normal footprint of the wall, such as the opposing back wall 34)—for example, in such a regard, there need not be a cut-out that occurs as the front wall 32 could simply be formed with the modified shape). In the illustrated embodiment, the cut-out feature 51 is defined along a top edge 33a of the front wall 32 of the bottom portion 30. The cut-out feature 51 is positioned on the front wall 32 of the bottom portion 30 to align with the perforation feature 50 of the top portion 20 when the bottom portion 30 is received within the top portion 20 (e.g., shown upon removal of the perforation feature 50, such as in FIG. 9). In some embodiments, the cut-out feature 51 is configured to enable the dispensing tap 92 to extend past or through the front wall 32 of the bottom portion 30 when the box 10 is converted into the bag-in-box dispenser. Along these lines, with reference to FIGS. 9-10, in some embodiments, the cut-out feature 51 defines a shape (e.g., a semi-circle, although other shapes are contemplated) that corresponds to a portion 91 of the dispensing tap 92 such that the cut-out feature 51 at least partially holds the dispensing tap 92 in position when the box 10 is converted into the bag-in-box dispenser. Although shown and described as being pre-removed, in some embodiments, the cut-out feature 51 may be removable such as by using a series of perforations—such as may be similar to the perforation feature 50 described herein.

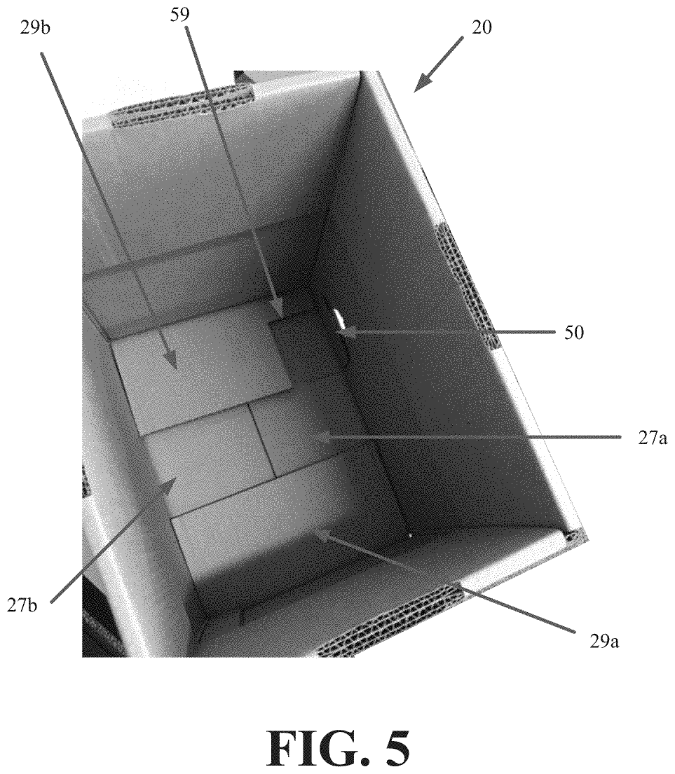

In some embodiments, the box 10 may be configured to enable easy removal of the perforation feature 50 and provide for space for a user to access the dispensing tap 92 of a stored bag 90 upon removal of the perforation feature 50. In such a regard, in some embodiments, the top flap may define a modified shape (e.g., modified from a normal footprint, such as defined by its opposing top flap). For example, a portion of a top flap may be cut-out (e.g., removed) and/or formed according to the modified shape. For example, with reference to FIGS. 5 and 7, a second side top flap 29b (which extends from the second side wall 28 of the top portion 20) defines a cut-out feature 57. The cut-out feature 57 (like the above described example cut-out feature 51) may be an area cut-out from the normal rectangular footprint of the second side top flap 29b (e.g., in some embodiments the top flap may define a corresponding modified shape (e.g., modified from a normal footprint of the top flap)—for example, in such a regard, there need not be a cut-out that occurs as the top flap could simply be formed with the modified shape). The cut-out feature 57 may be positioned on the second side top flap 29b to align with a portion 54b of the perforation feature 50 on the front top flap 27a when the top portion 20 is formed (e.g., shown in FIG. 5) so as to enable a user to access a dispensing tap 92 of a stored bag 90 within the box 10 upon removal of the perforation feature 50.

In some embodiments, the box 10 (or portions thereof) may be formed of double-walled corrugate to add strength to the box 10, such as may be beneficial for individual box shipping and/or passing the test standards noted herein. In some embodiments, both the top portion 20 and the bottom portion 30 are formed of double-walled corrugate. In some embodiments, the box 10 (or portions thereof) may be formed of additional layers of corrugate (e.g., triple-walled corrugate, or more), such as may be beneficial for further increased strength. In some embodiments, the box 10 (or portions thereof) may be formed of other types of material, such as cartonboard, microflute corrugate, etc.

FIG. 8 illustrates an example process an end user goes through to convert the now shipped box 10 into a bag-in-box dispenser. First, a user removes the perforation feature 50 by using the finger access portion 52, such as by inserting their finger into the finger access portion 52 and pulling the finger access portion 52 and the perforation feature 50 upwardly (e.g., step 110). With reference to FIG. 9, removal of the perforation feature 50 reveals the dispensing tap 92 of the stored bag 90, and the cut-out feature 51 of the bottom portion 30. With both portions 54a, 54b of the perforation feature 50 removed, a user can reach in and pull the dispensing tap 92 out and position it within the cut-out feature 51 (e.g., step 120, which is illustrated in completed form in FIG. 10) to position the dispensing tap 92 in a dispensing position. Notably, the dispensing tap 92 faces upwardly after completing step 120. Then, the user can flip (e.g., rotate) the box 10 over such that the dispensing tap 92 is on the bottom of the box 10 (e.g., step 130, which is illustrated in completed form in FIG. 11). This puts the box 10 into a dispensing orientation, and enables a user to activate dispensing using one or more dispensing features 96 (e.g., a lever for opening flow through the dispensing tap 92). Accordingly, the liquid within the bag 90 may flow through the outlet 98. Notably, the outlet 98 of the dispensing tap 92 is now positioned below the bottom of the box 10 (e.g., illustrated as line L) to encourage full dispensing from the bag 90 via gravity. Although the illustrated embodiment utilizes a dispensing tap with a lever, other types of dispensing taps are contemplated (e.g., valves, openings, nozzles, etc.). Of further note, the entire process may be completed without the end user having to remove the top or bottom box portions from each other and only requiring one flip of the box 10, which is beneficial for easy handling and keeping the heavy bag within the box 10 and intact. In some embodiments, the user may at least partially lift the top portion 20 to aid in converting the box into the bag-in-box dispenser, such as to aid in removal of the perforation feature 50 and/or positioning of the dispensing tap 92.

### Example Flowchart(s)

Embodiments of the present invention provide methods and systems for forming a box, shipping the box with a bag stored therein, and converting the box into the bag-in-box dispenser, according to various embodiments described herein. In this regard, associated systems and methods for manufacturing, shipping, and forming example box designs and converting into corresponding bag-in-box dispensers described herein are contemplated by some embodiments of the present invention. Such systems and methods may include various machines and devices, including for example box forming devices (e.g., for folding, gluing, and/or taping boxes, among other things) and/or corrugators. In this regard, known corrugators utilize web product (e.g., liner) and flute medium to form corrugated web product (which may be formed into any number of layered corrugate, such as conventional corrugate (liner, flute medium, liner) or double-walled corrugate (liner, flute medium, liner, flute medium, and liner)). The formed corrugated web product may then be cut (e.g., scored, sliced, perforated, etc.) as needed to form a box blank of the desired box (e.g., any of the box designs described herein). An example corrugator is further described in U.S. Publication No. 2019/0016081, which was filed Jul. 12, 2018, and entitled “Controls for Paper, Sheet, and Box Manufacturing Systems”, the contents of which is incorporated by reference herein in its entirety.

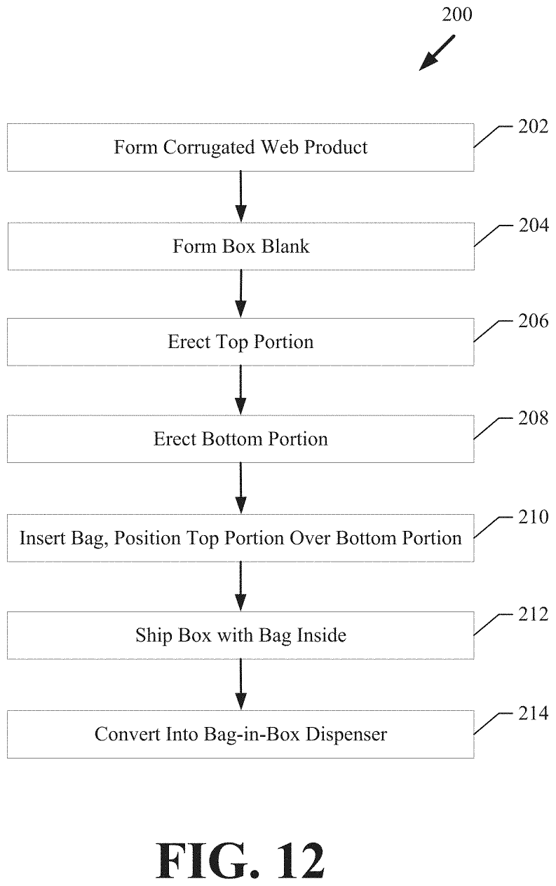

Various examples of the operations performed in accordance with some embodiments of the present invention will now be provided with reference to FIG. 12. In this regard, FIG. 12 illustrates a flowchart according to an example method for forming a box, shipping the box with a bag stored therein, and converting the box into the bag-in-box dispenser according to an example embodiment 200. The operations illustrated in and described with respect to FIG. 12 may, for example, be performed by, with the assistance of, and/or under the control of one or more of a user or a machine for performing the operation (e.g., a corrugator for forming the corrugated box blanks, a box-forming machine for forming the box or portions thereof, a bag loading machine for loading the bag into the box, etc.).

Operation 202 may comprise forming the corrugated web product, and operation 204 may comprise forming the box blank, such as may include both the top portion 20 and the bottom portion 30. As noted above, such operations may be performed by various known machines/devices, such as a corrugator.

Operation 206 may comprise erecting (e.g., forming) the top portion, which may occur using a box forming machine and/or manually via a user. Similarly, operation 208 may comprise erecting (e.g., forming) the bottom portion, which may also occur using a box forming machine and/or manually via a user. Operation 210 may include inserting the bag of liquid into the bottom portion and forming the completed box with stored bag therein by positioning the top portion thereover. In some embodiments, the operation 210 may include securing the top portion to the bottom portion, such as via tape, adhesive, etc. This may be completed by a machine/device and/or via a user.

Operation 212 may comprise shipping the box with stored bag therein, such as using individual box shipping means described herein. Then, such as upon arrival at the final destination, operation 214 may comprise converting the box into the bag-in-box dispenser, such as described further herein. This may be performed using a machine/device and/or via a user.

### CONCLUSION

Many modifications and other embodiments of the inventions set forth herein may come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

1. A corrugated box for shipping a bag of liquid stored therein and converting into a bag-in-box dispenser, the box comprising:
a top portion comprising a plurality of walls and a top, wherein the top portion defines an opening, wherein a first top flap extends from a first wall of the plurality of walls, wherein the top is formed from at least the first top flap being folded with respect to the first wall, wherein the top portion includes:
a perforation feature defined on the first wall and the first top flap, wherein the perforation feature is defined by a series of perforations and is removable from a remainder of the first wall and a remainder of the first top flap; and
a bottom portion comprising a plurality of walls and a bottom, wherein the bottom portion defines an opening configured to receive the bag of liquid, wherein the bottom portion is sized to fit within the opening of the top portion.

2. The box of claim 1, wherein the perforation feature defines a portion of the first wall that is sized to enable a dispensing tap of a stored bag to extend therethrough when the box is converted into the bag-in-box dispenser.

3. The box of claim 2, wherein the perforation feature is positioned along a top edge of the first wall such that when the box is converted into the bag-in-box dispenser and rotated, the dispensing tap is positioned at or adjacent a bottom of the bag.

4. The box of claim 2, wherein the bottom portion comprises a cut-out feature that defines a portion of a first wall of the plurality of walls of the bottom portion that is at least one of pre-removed or capable of being removed from a remainder of the first wall of the bottom portion, wherein the cut-out feature is positioned on the first wall of the bottom portion to align with the perforation feature of the top portion when the bottom portion is received within the top portion, wherein the cut-out feature is configured to enable the dispensing tap to extend past or through the first wall of the bottom portion when the box is converted into the bag-in-box dispenser.

5. The box of claim 4, wherein the cut-out feature defines a shape that corresponds to a portion of the dispensing tap such that the cut-out feature holds the dispensing tap in position when the box is converted into the bag-in-box dispenser.

6. The box of claim 4, wherein the cut-out feature is defined along a top edge of the first wall of the bottom portion.

7. The box of claim 1, wherein the perforation feature extends across the first wall and the first top flap such that removal of the perforation feature removes a portion of the first wall that is adjacent and continuous with a portion of the first top flap that is also removed.

8. The box of claim 7, wherein the perforation feature extends across an edge of the first wall defined by folding of the first top flap.

9. The box of claim 1, wherein the top portion further defines a finger access feature positioned adjacent to the perforation feature.

10. The box of claim 9, wherein the finger access feature is at least partially defined by a separate series of perforations and is removable separately from the perforation feature to enable easier access for a user to remove the perforation feature.

11. The box of claim 1, wherein a second top flap extends from a second wall of the top portion that is adjacent to the first wall, wherein the second top flap of the top portion defines a modified shape such that when the second top flap and the first top flap are folded to form the top, a user can access a dispensing tap of a stored bag within the box around or through the modified shape upon removal of the perforation feature.

12. The box of claim 11, wherein the modified shape defines a cut-out feature, wherein the cut-out feature of the second top flap defines a portion of the second top flap that is at least one of pre-removed or capable of being removed from the remainder of the second top flap and is positioned on the second top flap to align with a portion of the perforation feature on the first top flap so as to enable a user to access a dispensing tap of a stored bag within the box upon removal of the perforation feature.

13. The box of claim 1, wherein the bottom portion defines a side flap that is attached to an outside surface of one of the plurality of walls, wherein the side flap is attached to the outside surface of the one of the plurality of walls so as to be separated from the stored bag within the box to avoid damage to the stored bag during shipping.

14. The box of claim 1, wherein the top portion comprises a plurality of bottom flaps, wherein the plurality of bottom flaps each extend downwardly from a corresponding wall of the plurality of walls and are configured to fold into the opening of the top portion to define rollover flaps when the box is formed so as to provide increased vertical and lateral strength for the box.

15. The box of claim 1, wherein the top portion and the bottom portion are each formed of double-walled corrugate.

16. The box of claim 1, wherein the box is configured to store the bag of liquid with volume ranging from 3 gallons to 6 gallons and keep the bag from damage or leaking during individual box shipping.

17. The box of claim 16, wherein the box is designed to store the bag and pass individual box shipping test standards, including at least the 2018 International Safe Transit Association (ISTA) Series 6-Amazon.com-Ship In Own Container (SIOC) test protocol for at least one of Type A or Type B.

18. The box of claim 1, wherein the box is designed to survive individual box shipping such that the perforation feature is intact and the bag is free of damage or leaking so as to enable conversion of the box into the bag-in-box dispenser thereafter.

19. A system including the box of claim 1, wherein the system further includes the bag of liquid including a dispensing tap, wherein the bag is stored within the opening of the bottom portion of the box.

20. A box blank for a corrugated box for shipping a bag of liquid stored therein and converting into a bag-in-box dispenser, wherein the box blank is formed of corrugate and comprises:
a top portion comprising a plurality of panels, wherein the plurality of panels are configured to fold to form an opening when the top portion is formed into a box top portion, wherein a first top flap extends from a first panel of the plurality of panels, wherein the top portion defines:
a perforation feature defined on the first panel and the first top flap, wherein the perforation feature is defined by a series of perforations and is removable from a remainder of the first panel and a remainder of the first top flap; and
a bottom portion comprising a plurality of panels, wherein the plurality of panels are configured to fold to form an opening when the bottom portion is formed into a box bottom portion, wherein the opening is configured to receive the bag of liquid, wherein the bottom portion, when formed into the box bottom portion, is sized to fit within the opening of the formed box top portion.

21. The box blank of claim 20, wherein the perforation feature defines a portion of the first panel that is sized to enable a dispensing tap of a stored bag within the formed box to extend therethrough when the box is further converted into the bag-in-box dispenser.

22. The box blank of claim 21, wherein the perforation feature is positioned along a top edge of the first panel such that when the box is converted into the bag-in-box dispenser and rotated, the dispensing tap is positioned at or adjacent a bottom of the bag.

23. The box blank of claim 21, wherein the bottom portion comprises a cut-out feature that defines a portion of a first panel of the plurality of panels of the bottom portion that is at least one of pre-removed or capable of being removed from a remainder of the first panel of the bottom portion, wherein the cut-out feature is positioned on the first panel of the bottom portion to align with the perforation feature of the top portion when the formed box bottom portion is received within the formed box top portion, wherein the cut-out feature is configured to enable the dispensing tap to extend past or through the first panel of the formed box bottom portion when the box is further converted into the bag-in-box dispenser.

24. The box blank of claim 23, wherein the cut-out feature defines a shape that corresponds to a portion of the dispensing tap such that the cut-out feature is designed to hold the dispensing tap in position when the box is further converted into the bag-in-box dispenser.

25. The box blank of claim 20, wherein the perforation feature extends between the first panel and the first top flap such that removal of the perforation feature removes a portion of the first panel that is adjacent and continuous with a portion of the first top flap that is also removed.

26. The box blank of claim 20, wherein the top portion and the bottom portion are each formed of double-walled corrugate.

27. The box blank of claim 20, wherein the box, when formed, is configured to store the bag of liquid with volume ranging from 3 gallons to 6 gallons and keep the bag from damage or leaking during individual box shipping.

28. The box blank of claim 27, wherein the box, when formed, is designed to store the bag and pass individual box shipping test standards, including at least the 2018. International Safe Transit Association (ISTA) Series 6-Amazon.com-Ship In Own Container (SIOC) test protocol for at least one of Type A or Type B.

29. The box blank of claim 20, wherein the box, when formed, is designed to survive individual box shipping such that the perforation feature is intact and the bag is free of damage or leaking so as to enable conversion of the box into the bag-in-box dispenser thereafter.

30. A method of manufacturing a box blank for a corrugated box for shipping a bag of liquid stored therein and converting into a bag-in-box dispenser, the method comprising:
forming corrugated web product;
cutting out a top portion of the box blank from the corrugated web product, wherein the top portion comprises a plurality of panels, wherein the plurality of panels are configured to fold to form an opening when the top portion is formed into a box top portion, wherein a first top flap extends from a first panel of the plurality of panels, wherein the top portion defines:
a perforation feature defined on the first panel and the first top flap, wherein the perforation feature is defined by a series of perforations and is removable from a remainder of the first wall and a remainder of the first top flap; and
cutting out a bottom portion of the box blank from the corrugated web product, wherein the bottom portion comprises a plurality of panels, wherein the plurality of panels are configured to fold to form an opening when the bottom portion is formed into a box bottom portion, wherein the opening is configured to receive the bag of liquid, wherein the bottom portion, when formed into the box bottom portion, is sized to fit within the opening of the formed box top portion.

31. The method of claim 30 further comprising:
erecting the box top portion; and
erecting the box bottom portion.

32. The method of claim 31 further comprising:
inserting the bag of liquid into the opening of the box bottom portion; and
sliding the box top portion over the box bottom portion with the bag stored therein.
